(19) United States
(12) Patent Application Publication
(10) Pub. No.: US 2013/0221755 A1
(43) Pub. Date: Aug. 29, 2013

(54) Circuit Arrangement for Setting a Potential of a Photovoltaic Generator

(71) Applicant: SMA Solar Technology AG, (US)

(72) Inventor: Andreas Falk, Kassel (DE)

(73) Assignee: SMA Solar Technology AG, Niestetal (DE)

(21) Appl. No.: 13/860,805

(22) Filed: Apr. 11, 2013

Related U.S. Application Data
(63) Continuation of application No. PCT/EP2011/069529, filed on Nov. 7, 2011.

(30) Foreign Application Priority Data
Nov. 9, 2010 (DE) 102010060463.1

(51) Int. Cl. G05F 3/18; H02J 1/06

(52) U.S. Cl. CPC G05F 3/18; H02J 1/06
USPC 307/100; 323/231

(57) ABSTRACT

A circuit arrangement for setting a potential of a photovoltaic generator with respect to a ground potential (GND) includes at least one first resistance connected between a negative output of the photovoltaic generator and a ground connection, and a series circuit including at least one second resistance and a breakdown diode connected in series between a positive output of the photovoltaic generator and the ground connection to which the ground potential (GND) is applied. Alternatively, the circuit arrangement includes at least one first resistance connected between a positive output of the photovoltaic generator and a ground connection, and a series circuit including at least one second resistance and a breakdown diode connected in series between a negative output of the photovoltaic generator and the ground connection to which the ground potential (GND) is applied.

### REFERENCE TO RELATED APPLICATIONS

This application is a continuation application of International Patent Application No. PCT/EP2011/069529, filed on Nov. 7, 2011, which claims priority to German Patent Application No. 10 2010 060 463.1, filed on Nov. 9, 2010, the contents of which are hereby incorporated by reference in their entirety.

### FIELD

The disclosure relates to a circuit arrangement for setting a potential of a photovoltaic generator with respect to a ground potential, and to a photovoltaic installation having at least one photovoltaic generator and such a circuit arrangement.

### BACKGROUND

Photovoltaic generators, hereafter referred to as PV generators, are used to convert solar energy to electrical energy. As part of a photovoltaic installation, analogously referred to in the following text as a PV installation, PV generators are normally coupled to one or more inverters, which convert the direct-current produced by the PV generators to alternating current for feeding into a public power supply grid or a private power supply grid (stand-alone operation).

PV generators normally comprise a plurality of photovoltaic modules (PV modules), which in turn each have a multiplicity of photovoltaic cells (PV cells). Frequently, a plurality of PV modules are connected in series to form a so-called string. One or more strings in parallel are then connected to an inverter. Because the PV modules are connected in series, this results in the PV generator having an output voltage in the range from about 500 to 1500 V, depending on the system design. This relatively high voltage reduces resistive losses in the direct-current lines which run between the PV generator and the inverter. It is unusual for PV generators to have an even higher voltage, for insulation reasons.

The direct-current input stages of inverters are frequently designed to be floating. Because the insulation resistances, particularly of the direct-current lines which run between the PV generators and the inverters, are not infinitely high, a potential occurs at the positive pole and negative pole during operation which is approximately symmetrical about the ground potential. For example, if the photovoltaic voltage at the output of a PV generator is 1000 V, the negative pole of the PV generator is at a potential of about −500 V with respect to the ground potential, and the positive pole is at a potential of approximately +500 V with respect to the ground potential. Because of the design, an excessively high negative potential of the PV module or parts of the PV module with respect to the ground potential is undesirable in some types of PV modules. In other types, an excessively high positive potential is undesirable.

By way of example, in the case of PV modules using thin-film technology, which have electrodes composed of a conductive metallic oxide (TCO—transparent conductive oxide), increased corrosion on the electrodes can be observed when the layer is at a negative potential with respect to the ground potential. The increased corrosion results in undesirable cell degradation, which leads to a decrease in the power from the PV modules. It is therefore advantageous to keep PV modules such as these at a positive potential with respect to the ground potential.

In the case of polycrystalline PV modules with back side contacts, negative charges can occur on the cell surface, as a result of which the recombination rate of the charge carriers rises, resulting in a considerable efficiency reduction. However, such charging can be prevented by the PV module being at a negative potential with respect to the ground potential. In contrast to the example mentioned above, it is therefore advantageous for PV modules such as these to be at a negative potential with respect to the ground potential.

In order to prevent the potential-dependent cell degradation in the case of modules using thin-film technology, it is known from the document DE 20 2006 008 936 U1 for the negative pole of a PV generator to be connected to the ground potential when floating inverters are used, thus preventing parts of the PV generator being operated at a negative potential with respect to the ground potential. However, this results in higher voltages with respect to the ground potential occurring at the positive pole of the PV generator. In the case of PV modules, because of the limited dielectric strength, a predetermined potential difference with respect to the environment, that is to say with respect to the ground potential, must not be exceeded, in order to prevent possible destruction (breakdown) of the electrical insulation. The maximum permissible voltage is referred to in the following text as the insulation limit voltage. The insulation limit voltage is normally approximately 1000 V. The fixing of the negative pole of a PV generator at the ground potential therefore limits the useable output voltage range of a PV generator to a photovoltaic voltage which is lower than the insulation limit voltage.

It is known from the document DE 10 2007 050 554 A1 to apply a high positive bias voltage (with respect to the ground potential) to the positive pole of a photovoltaic generator, with the aid of a voltage source, which also shifts the potential of the negative pole of the photovoltaic generator to a more positive potential. Preferably the potential of the negative pole is shifted to a positive potential with respect to the ground potential, in order as far as possible to prevent corrosion. Only in the event of a photovoltaic voltage which exceeds the bias voltage, for example under open circuit conditions, corrosion protection is no longer provided. However, the described method has the disadvantage that there is a permanently high potential at the positive pole of the PV generator. This can have long-term effects on the insulation of the PV generator. Furthermore, if the PV generator is formed from a plurality of partial generators which can each be connected separately, a plurality of independent voltage sources must also be provided, in order to produce the bias voltages for the partial generators.

### SUMMARY

The present disclosure provides a circuit arrangement in which the potential of a photovoltaic generator is set in a simple and uncomplicated manner to a value which protects the insulation and prevents corrosion as far as possible for the PV generator.

In a first embodiment, a circuit arrangement for setting a potential of a PV generator with respect to a ground potential is disclosed. The circuit arrangement is distinguished in that a negative connection of the PV generator is connected to a ground connection via at least one resistor and a positive connection of the PV generator is connected to a ground connection via a series circuit comprising at least one second resistor and a breakdown diode, to which ground connection the ground potential is applied.

In a second embodiment, a circuit arrangement is disclosed in which a positive connection of the PV generator is connected to a ground connection via at least one resistor, and a negative connection of the PV generator is connected to a ground connection via a series circuit comprising at least one second resistor and a breakdown diode, to which ground connection the ground potential is applied.

For the purposes of this application, a breakdown diode is a diode which has a breakdown voltage of a defined magnitude in the reverse-biased direction. When the breakdown voltage is exceeded, the current/voltage characteristic of the diode rises steeply. By way of example, one or more series-connected zener diodes, avalanche diodes or suppressor diodes can be used as breakdown diodes. Suppressor diodes are also referred to as TVS (Transient Voltage Suppressor) diodes.

Up to an output voltage of the PV generator which is less than the breakdown voltage of the breakdown diode, the negative (first variant) or positive (second variant) connection of the PV generator is essentially at the ground potential, because of the circuit arrangement. If the output voltage rises further, the potential at this connection then rises, but only with a low gradient, which is governed by the ratio of the resistance values of the second resistor to the first resistor.

If the resistance values are chosen appropriately, this prevents the insulation limit voltage of the PV generator from being exceeded. On the one hand, this prevents direct insulation breakdown, and on the other hand it prevents permanent loading of the electrical insulation of the PV modules in a PV generator, since a potential which is high with respect to the ground potential is not present all the time.

The PV generator is operated as far as possible at a specific (positive or negative) bias voltage potential with respect to the ground potential, as long as the magnitude of the voltage of the PV generator provides that. In the case of the circuit arrangement according to the first embodiment, this is desirable, for example, with regard to corrosion protection of TCO electrodes of PV modules using thin-film technology. In the case of the circuit arrangement according to the second embodiment, this is desirable, for example, with respect to the efficiency of polycrystalline PV modules with back side contacts.

According to a third embodiment, a PV installation having at least one PV generator and at least one inverter with the PV installation having a circuit arrangement such as this for setting a potential of the at least one PV generator is disclosed. The advantages correspond to those of the first and second embodiments.

### BRIEF DESCRIPTION OF THE DRAWINGS

The invention will be explained in more detail in the following text using exemplary embodiments and with the aid of three figures, in which:

FIG. 1 shows a first example embodiment of a PV installation with a circuit arrangement for potential setting,

FIG. 2 shows a second example embodiment of a PV installation with a circuit arrangement for potential setting, and

FIG. 3 shows a third example embodiment of a PV installation with a circuit arrangement for potential setting.

### DETAILED DESCRIPTION

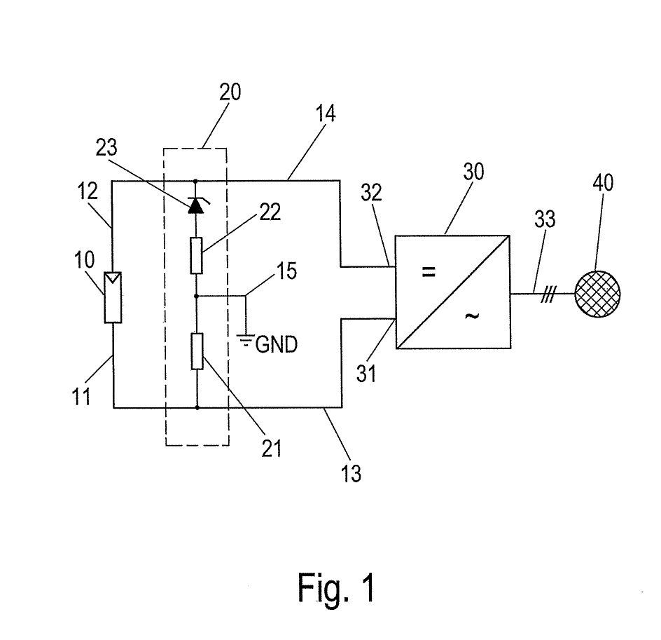

FIG. 1 shows a schematic illustration of a PV installation. The PV installation comprises a PV generator 10 with a negative connection 11, also referred to as a negative pole, and a positive connection 12, also referred to as a positive pole. The PV generator 10 is connected via its connections 11, 12 and direct-current lines 13, 14 to direct-current inputs 31, 32 of corresponding polarity of an inverter 30. The inverter 30 furthermore has an alternating-current output 33, via which electrical power which is produced by the PV generator 10 and is converted by the inverter 30 is fed into a power supply grid 40. By way of example, the inverter 30 is designed for a three-phase alternating-current feed. The inverter 30 is galvanically isolating in one embodiment, for example, by having a transformer via which the current is fed into the power supply grid. The direct-current inputs 31, 32 are therefore initially floating with respect to the alternating-current output 33.

FIG. 1 shows only those elements of the PV installation which are essential for the purposes of the application. By way of example, switching or protection members (for example disconnectors, AC contactors) and/or filters (for example sine filters) and/or power supply grid monitoring devices, which are not illustrated, may be provided on the alternating-current side of the inverter 30. It is also possible for the inverter 30 to be designed in ways other than the three-phase design illustrated, for example a single-phase design. Further elements which are not illustrated here, such as switching members (for example DC contactors) and/or protection members, can likewise be arranged on the direct-current side in the connection between the PV generator 10 and the inverter 30.

By way of example, the PV generator 10 is symbolized in FIG. 1 by the circuit symbol for a single photovoltaic cell. In an implementation of the illustrated PV installation, the PV generator 10 may be a single PV module, or a plurality of PV modules connected together, in particular in a string configuration.

In addition to the elements mentioned above, the PV installation as shown in FIG. 1 comprises a circuit arrangement 20 for setting a potential of the PV generator 10. The circuit arrangement 20 is connected to the negative connection 11 and to the positive connection 12 of the PV generator 10. Furthermore, a connection is provided to a ground connection 15, to which the ground potential GND is applied. The circuit arrangement 20 comprises a first resistor 21, via which the negative connection 11 of the PV generator 10 is connected to the ground connection 15. The circuit arrangement 20 furthermore has a second resistor 22, which is connected in series with a breakdown diode 23. The positive connection 12 of the PV generator 10 is connected to the ground connection 15 via the second resistor 22 and the breakdown diode 23, with the breakdown diode 23 being arranged such that it is reverse-biased when there is a positive potential on the positive connection 12 with respect to the ground potential GND.

By way of example, a zener diode is used as the breakdown diode 23 in the example embodiments. In order to simplify the description, the breakdown diode 23 is therefore also referred to in the following text as a zener diode 23. However, it is alternatively also possible to use avalanche or TVS diodes. It is also feasible for the breakdown diode 23 to be formed by a plurality of such diodes, for example a plurality of zener diodes, connected in series, particularly when the aim is to achieve a breakdown voltage of several hundred volts.

The use of the illustrated circuit arrangement 20 assumes that the DC voltage inputs 31, 32 of the inverter 30 are either designed to be floating or have only a high-impedance connection to the ground potential GND, or to a voltage source which is connected to the ground potential GND. The circuit arrangement 20 described in this example embodiment is, as is described in the following text, designed for use with those PV modules which are intended to be at a positive potential with respect to the ground potential. By way of example, the PV generator 10 accordingly has PV modules using thin-film technology.

The zener diode 23 has a breakdown voltage which is in the same order of magnitude as the maximum desired voltage at the positive connection 12 of the PV generator with respect to the ground potential GND. The breakdown voltage is advantageously somewhat lower than the maximum desired voltage. In general, the insulation limit voltage of the PV generator 10 is regarded as the maximum desired voltage.

It is assumed that the PV generator 10 is floating and has a sufficiently high impedance with respect to the ground potential GND that these resistance values can be ignored. If the voltage of the PV generator 10 is lower than the breakdown voltage of the zener diode 23, the branch which is formed from the zener diode 23 and the second resistor 22 has a considerably higher impedance than the first resistor 21. The entire voltage of the PV generator 10 is therefore dropped across the series circuit formed by the second resistor 22 and the zener diode 23. In consequence, the negative connection 11 of the PV generator 10 is essentially at the ground potential GND. If the voltage of the PV generator 10 rises further, the voltage component which is above the breakdown voltage of the zener diode 23 is dropped across the first resistor 21 and the second resistor 22 in the ratio of their resistance values. In order to ensure that the voltage which is dropped across the second resistor 22 is not excessively high and that the insulation limit voltage is exceeded at the positive pole, the resistance value of the second resistor 22 should be at least less than that of the first resistor 21, and the resistance value of the second resistor 22 is preferably many times less than that of the first resistor 21.

By way of example, the following text will consider the potential profile at a PV generator 10 as a function of its output voltage, in the situation where the first resistor 21 has a value of 100 kOhm, and the second resistor 22 has a value of 25 kOhm. A diode having a breakdown voltage of 800 V is assumed to be used as the zener diode 23.

Up to an output voltage below the breakdown voltage of 800 V, the negative connection 11 of the PV generator 10 is essentially at the ground potential GND. If the output voltage rises further, for example to 1000 V, it is in consequence 200 V above the breakdown voltage of the zener diode 23. This 200 V is dropped across the resistors 21 and 22 in the ratio of their resistance values, that is to say 160 V across the first resistor 21 and 40 V across the second resistor 22. The positive pole 12 of the PV generator 10 is therefore at a potential of +840 V with respect to the ground potential GND, and the negative pole 11 is at a potential of −160 V with respect to the ground potential.

If the maximum voltage of the PV generator 10 is assumed to be 1500 V, the potential at the positive pole 12 is correspondingly +940 V with respect to the ground potential GND, and the negative pole 11 is at a potential of −560 V with respect to the ground potential. An assumed insulation limit voltage of, for example, 1000 V is not exceeded.

The circuit arrangement 20 therefore prevents the permissible insulation limit voltage from being exceeded without the positive connection 12 of the PV generator 10 being kept permanently at a high positive potential. This prevents both direct insulation breakdown, as well as permanent loading of the electrical insulation of the PV modules in a PV generator 10. Furthermore, provided that the magnitude of the voltage of the PV generator 10 allows this, the PV generator 10 is operated as far as possible with a positive bias-voltage potential with respect to the ground potential GND, and this is once again desirable with respect to corrosion protection of TCO electrodes in PV generators 10 using thin-film technology.

Furthermore, the first resistor 21 and the second resistor 22 limit the current flow when the voltage of the PV generator 10 exceeds the breakdown voltage of the zener diode 23, or when a short-circuit occurs with respect to the ground potential, a so-called ground fault, at the PV generator 10, on the direct-current lines 13, 14 or in the direct-current input stage of the inverter 30. In the event of a ground fault, at most, the entire voltage of the PV generator 10 can be present at the first resistor 21. In order to comply with legal requirements that at most a certain power loss, for example, 60 W, may occur at a fault location in the event of a fault, the first resistor 21 should therefore be chosen to be at least sufficiently large that this power loss is not exceeded at the maximum voltage to be expected from the PV generator 10.

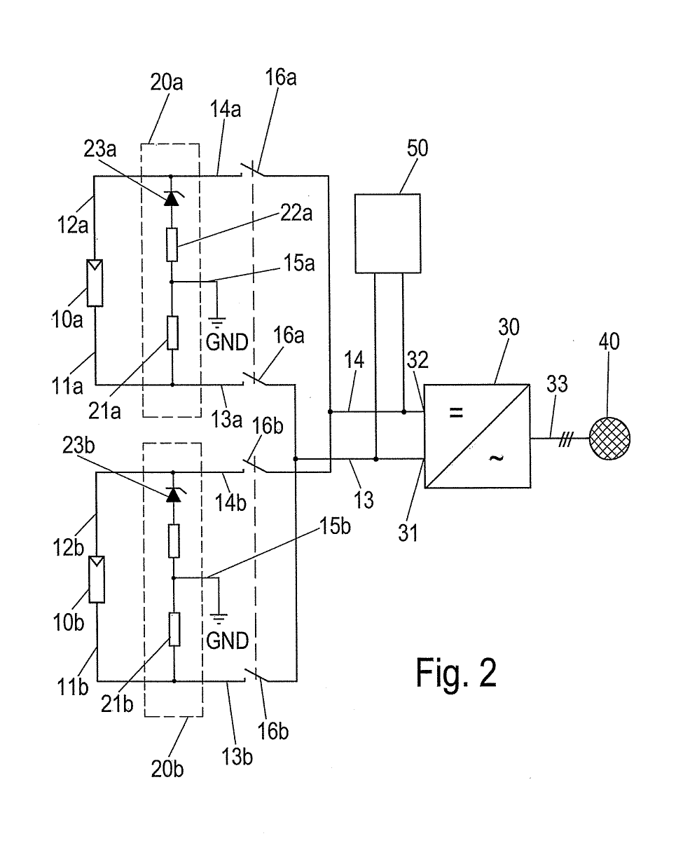

FIG. 2 shows a further example embodiment of a PV installation with a circuit arrangement for potential setting. Equal or functionally equivalent elements to those in FIG. 1 are provided with the same reference symbols in this figure as in FIG. 1.

In contrast to the example embodiment in FIG. 1, there are two PV generators 10a, 10b in the PV installation illustrated in FIG. 2. Each of the PV generators 10a, 10b is provided with a circuit arrangement for potential setting, and these are correspondingly identified by the reference symbols 20a and 20b. The two PV generators 10a, 10b are connected to an inverter 30 via corresponding direct-current lines 13a, 13b and 14a, 14b via switching members 16a and 16b, and via common direct-current lines 13, 14. In order to feed in the inverter 30 is coupled again via AC voltage outputs 33 to a power supply grid 40. Once again, the PV generator 10 comprises, for example, PV modules using thin-film technology.

The switching members 16a, 16b allow selective connection and disconnection of both of the PV generators 10a, 10b, for example in the event of shadowing or partial shadowing of one of the two PV generators 10a, 10b, or for servicing and repair purposes.

The design of each of the circuit arrangements 20a, 20b corresponds to that of the circuit arrangement 20 described in the first example embodiment in FIG. 1, and correspondingly comprises a first resistor 21a or 21b, a second resistor 22a or 22b, and a zener diode 23a or 23b, respectively. In view of the simple and low-cost design of the circuit arrangement 20 it is advantageous to provide each PV generator 10 with its own circuit arrangement 20a, 20b, as illustrated. In addition, when a PV generator 10a, 10b is decoupled from the inverter 30 by opening the switching member 16a, 16b, the respective circuit arrangement 20a, 20b ensures sensible potential setting, in particular limiting of the maximum possible positive potential at the positive pole 12a, 12b of the respective PV generator 10a, 10b.

A further difference from the example embodiment in FIG. 1 is that an insulation measurement device 50 is provided in the direct-current circuit. An insulation measurement device 50 such as this may be provided separately from the inverter 30, as illustrated, or may be integrated therein.

The insulation measurement device 50 is connected to both poles of the direct-current input 31, 32 of the inverter 30. The insulation resistance at the connections of the insulation measurement device is determined using an appropriate method. If the insulation resistance is less than a predetermined minimum value, it is possible to deduce that there is an insulation problem in the inverter 30, in the direct-current lines 13 or 14; 13a, 13b or 14a, 14b, or within one of the PV generators 10a, 10b.

In an insulation measurement device 50 such as this, resistors are normally used between its connections and the ground potential, in order to measure the insulation resistance. The values of such resistors which are used in the insulation measurement device must be taken into account in a suitable form when choosing the values of the first resistor 21 and of the second resistor 22. Furthermore, the deliberate imbalance in the potential distribution about the ground potential GND which results from the circuit arrangement 20 must be taken into account in the evaluation of the imbalance of a current flow to the ground potential GND within the insulation device 50, in order to preclude a false alarm. If, as in the case illustrated in FIG. 2, the effective resistance values which result from the interconnection of the circuit arrangements 20a, 20b vary as a result of the different switching states of the switching members 16a, 16b, this must also be taken into account in the evaluation of the imbalance by the resistors of the insulation measurement device 50.

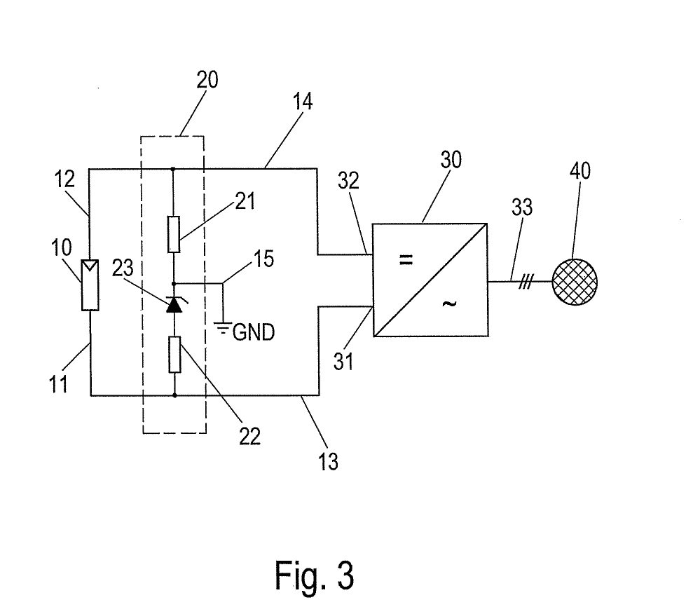

FIG. 3 shows a schematic illustration of a further example embodiment of a PV installation having a circuit arrangement for potential setting. Again same reference symbols denote same or functionally equivalent elements as those in FIG. 1.

The PV installation once again comprises a PV generator 10 with a negative connection 11 and a positive connection 12. As in the case of the example embodiment shown in FIG. 1, the PV generator is connected via direct-current lines 13, 14 to an inverter 30, which is once again coupled via an AC voltage output 33 to a power supply grid 40 in order to feed in. With respect to the design of the inverter 30, reference is made to the statements in conjunction with FIG. 1.

The PV installation likewise has a circuit arrangement 20 for setting a potential of the PV generator 10, which comprises a first resistor 21, a second resistor 22 and a breakdown diode 23. By way of example, the breakdown diode 23 may once again be a zener diode, and is also referred to as a zener diode 23 in the following text. In contrast to the first two example embodiments, in this case the positive connection 12 of the PV generator 10 is connected via the first resistor 21 to a ground connection 15 while, in contrast, the negative connection 11 of the PV generator 10 is connected to the ground connection 15 via a series circuit comprising a second resistor 22 and a zener diode 23. As before, the zener diode 23 is in this case arranged in the reverse-biased direction.

The circuit arrangement 20 is therefore designed analogously to the previous example embodiments, but with the PV generator 10 being operated as far as possible at a negative bias voltage potential with respect to the ground potential GND as is advantageous, for example, for efficiency, when polycrystalline PV modules with back side contacts are used as PV modules 10. Furthermore, this prevents the permissible insulation limit voltage from being exceeded, in the same way as in the example embodiments in FIGS. 1 and 2.

A PV installation as is illustrated in FIG. 2, in which there are a plurality of PV generators, may also, of course, be equipped with separate circuit arrangements 20 as shown in FIG. 3. The use of the circuit arrangements 20 as shown in FIG. 3 is likewise possible in conjunction with an insulation measurement device.

1. A circuit arrangement for setting a potential of a photovoltaic generator with respect to a ground potential (GND), comprising:
at least one first resistance connected between a negative output of the photovoltaic generator and a ground connection; and
a series circuit comprising at least one second resistance and a breakdown diode connected in series between a positive output of the photovoltaic generator and the ground connection to which the ground potential (GND) is applied.

2. The circuit arrangement as claimed in claim 1, wherein the breakdown diode is a zener diode, an avalanche diode or a suppressor diode.

3. The circuit arrangement as claimed in claim 1, wherein the breakdown diode comprises a series circuit of a plurality of zener diodes, avalanche diodes or suppressor diodes.

4. The circuit arrangement as claimed in claim 1, wherein the breakdown diode has a breakdown voltage which is of the same order of magnitude as an insulation limit voltage of the photovoltaic generator.

5. The circuit arrangement as claimed in claim 1, wherein the at least one second resistance has a resistance value of more than 1 kOhm.

6. The circuit arrangement as claimed in claim 1, wherein the resistance value of the at least one second resistance is less than the resistance value of the at least one first resistance.

7. The circuit arrangement as claimed in claim 6, wherein the resistance value of the at least one second resistance is many times less than the resistance value of the at least one first resistance.

8. A circuit arrangement for setting a potential of a photovoltaic generator with respect to a ground potential (GND), comprising:
at least one first resistance connected between a positive output of the photovoltaic generator and a ground connection; and
a series circuit comprising at least one second resistance and a breakdown diode connected in series between a negative output of the photovoltaic generator and the ground connection to which the ground potential (GND) is applied.

9. The circuit arrangement as claimed in claim 8, wherein the breakdown diode is a zener diode, an avalanche diode or a suppressor diode.

10. The circuit arrangement as claimed in claim 8, wherein the breakdown diode comprises a series circuit of a plurality of zener diodes, avalanche diodes or suppressor diodes.

11. The circuit arrangement as claimed in claim 8, wherein the breakdown diode has a breakdown voltage which is of the same order of magnitude as an insulation limit voltage of the photovoltaic generator.

12. The circuit arrangement as claimed in claim 8, wherein the at least one second resistance has a resistance value of more than 1 kOhm.

13. The circuit arrangement as claimed in claim 8, wherein the resistance value of the at least one second resistance is less than the resistance value of the at least one first resistance.

14. The circuit arrangement as claimed in claim 13, wherein the resistance value of the at least one second resistance is many times less than the resistance value of the at least one first resistance.

15. A photovoltaic installation having at least one photovoltaic generator and at least one inverter, wherein the photovoltaic installation has a circuit arrangement for setting a potential of a photovoltaic generator with respect to a ground potential (GND), comprising:
at least one first resistance connected between a negative output of the photovoltaic generator and a ground connection; and
a series circuit comprising at least one second resistance and a breakdown diode connected in series between a positive output of the photovoltaic generator and the ground connection to which the ground potential (GND) is applied, or the circuit arrangement comprising:
at least one first resistance connected between a positive output of the photovoltaic generator and a ground connection; and
a series circuit comprising at least one second resistance and a breakdown diode connected in series between a negative output of the photovoltaic generator and the ground connection to which the ground potential (GND) is applied.

16. The photovoltaic installation as claimed in claim 15, having at least two photovoltaic generators and a respective circuit arrangement for each of the at least two photovoltaic generators.

17. The photovoltaic installation as claimed in claim 15, further comprising at least one insulation measurement device configured to determine an insulation resistance of the inverter, of the photovoltaic generator or of direct-current lines, via which the photovoltaic generator is connected to the inverter.
